(19) United States
(12) Patent Application Publication
(10) Pub. No.: US 2015/0213783 A1
(43) Pub. Date: Jul. 30, 2015

(54) TOUCH ELECTRONIC DEVICE AND TOUCH LINK METHOD

(71) Applicant: MediaTek Singapore Pte. Ltd., Singapore (SG)

(72) Inventors: Xiaomeng YAN, Tianjin (CN); Chin-Ying HSIEH, New Taipei City (TW); Yao-Ting WU, Taipei (TW)

(21) Appl. No.: 14/607,271

(22) Filed: Jan. 28, 2015

(30) Foreign Application Priority Data
Jan. 29, 2014 (CN) 201410043779.5

(51) Int. Cl. G09G 5/12; G06F 3/14; G06F 3/041

(52) U.S. Cl. CPC G09G 5/12; G06F 3/0412; G06F 3/1423; G09G 2370/16; G09G 2370/22

(57) ABSTRACT

The present invention provides a touch electronic device and a touch link method. The touch electronic device includes a touch panel and a touch connection module. The touch connection module includes a sensing module and a connection module. The sensing module is utilized to detect a physical adjacency between the touch electronic device and a plurality of first touch electronic devices. The connection module is utilized to develop a touch link between the touch electronic device and the plurality of first touch electronic devices through the touch panel when the sensing module detects the physical adjacency. The touch electronic device and the touch link method of the preset invention could be utilized to easily develop the touch link among at least two electronic devices for data transmission.

### CROSS REFERENCE TO RELATED APPLICATIONS

This application claims priority of China Patent Application No. 201410043779.5, filed on Jan. 29, 2014, the entirety of which is incorporated by reference herein.

### BACKGROUND OF THE INVENTION

1. Field of the Invention

The present invention relates to an electronic device, and especially to a touch electronic device and a touch link method using the same.

2. Description of the Related Art

Near Field Communication (NFC) is a contactless technology for identification and interconnection. Near Field Communication allows users to intuitively exchange information, access content and services by using the near field magnetic communication (such as the near field magnetic communication of 13.56 MHz) between mobile devices, consumer electronics, PCs or smart electronic devices.

Due to the maturity of the market, the mobile phone with NFC can either support the function of the mobile payment or serve as a point of sale (POS) apparatus. However, a proximity card reader or like elements must be added to the handheld device because NFC operates by sending and receiving signals based on magnetic fields, and that will make the size of the handheld device larger, and the layout and the elements of the handheld device might be limited.

A touch-link technology of a touch panel device which uses the existing panel and driver IC for communication was developed recently, and has been described in US 2011/0304583, US 2013/0147760, CN 102916729A. The touch panel device includes a touch sensor. At least a part of the touch sensor includes at least a part of the touch panel of the touch panel device. The touch panel can be a touch panel without a display function, such as a touch pad, or one with a display function, such as the touch screen. The touch sensor includes the driving electrodes and the sensing electrodes set on the board for forming the capacitance structure. At least one of the driving electrodes and the sensing electrodes is used as the sending electrode, and at least one is used as the receiving electrode. Thus, the signal can be sent and received by the existing electrodes and driver IC of the touch panel device for achieving the touch connection based on the electric field without an additional proximity card reader or like element, reducing the size and the cost of the touch panel device.

FIG. 1 is a schematic diagram of the touch connection between a first touch panel device and a second touch panel device in accordance with the prior art. As shown in FIG. 1, there are near fields 103a and 103b between the first touch panel device 101 and the second touch panel device 102. It should be noted that the first touch panel device 101 and the second touch panel device 102 are enabled to send and receive the signal. The first touch panel device 101 sends the signal to the second touch panel device 102 through a communication media which has an electric field pointed to the second touch panel device 102 (the near field 103a as shown in FIG. 1). The second touch panel device 102 sends the signal to the first touch panel device 101 through a communication media which has an electric field pointed to the first touch panel device 101 (the near field 103b as shown in FIG. 1). The X channel and the Y channel shown in FIG. 1 are used as the sending electrodes and the receiving electrodes set on the board for forming the capacitance structure.

FIG. 2 is a logic chart for achieving the touch connection system between the first touch panel device and the second touch panel device in accordance with the prior art. The first touch panel device includes a signal sending system 201 shown in FIG. 2, and the second touch panel device includes a signal receiving system 202 shown in FIG. 2. The signal sending system 201 includes a touch-and-connect request signal generation unit 211, a communication connection establishing unit 212 and a first communication unit 213. The touch-and-connect request signal generation unit 211 is used to generate a request signal for sending touch connection to the second touch panel 102 through the sending electrode. The communication connection establishing unit 212 establishes a communication connection with the second touch panel device 102 after the receiving electrodes receive a response signal responded from the second touch panel device 102. The first communication unit 213 sends the communication information or the data to the second touch panel device 102 through the sending electrodes of the touch panel (not shown) after the communication connection is established.

The signal receiving system 202 includes a touch-and-connect request response unit 221, a communication connection establishing unit 222 and a second communication unit 223. The touch-and-connect request response unit 221 responds an acknowledge signal to the first touch panel device 101 through the sending electrodes after the receiving electrodes receive a touch-and-connect request signal sent from the first touch panel device 101. The communication connection establishing unit 222 establishes the communication connection with the first touch panel device 101 after the touch-and-connect request response unit 221 responses the acknowledge signal to the first touch panel device 101. The second communication unit 223 receives the communication information or the data sent from the first touch panel device 101 through the receiving electrodes after the communication connection is established.

FIG. 3 is a schematic illustrating the transmission and reception of the signal by the electrodes of the touch panel of the prior art. As shown in FIG. 3, the touch sensor (not shown) includes the sending electrodes 311, 321 and the receiving electrodes 312, 322 disposed on the board (such as the first touch panel 301 or the second touch panel 302) for forming the capacitance structure. The sending electrodes 311, 321 are used to send the signal, and the receiving electrodes 312, 322 are used to receive the signal.

FIG. 4 is a flow chart of the touch connection method in accordance with the prior art. First, in step S401, the touch-and-connect request signal generation unit 211 generates a touch-and-connect request signal, and sends it to the second touch panel device 102 through the sending electrodes. Then the receiving electrodes receive the acknowledge signal responded from the second touch panel device 102 (step S402). After that, the communication connection establishing unit 212 establishes the communication connection with the second touch panel device 102 (step S403). Finally, the method goes to step S404, and the first communication unit 213 sends the communication information or the data to the second touch panel device 102 through the sending electrodes.

Compared to ordinary keyboards or mouse devices, the touch operation can provide a more convenient and user-friendly operation method to users. Accordingly, more and more electronic devices are equipped with the touch function. However, the touch operation is usually the one-to-one operation between the user and the electronic device, or the one-to-one operation between two electronic devices. In addition, when the user wants to transmit different files to at least two electronic devices or share the same data among different electronic devices, it is very inconvenient to set up the network and connection for each electronic device. Therefore, a touch electronic device and data transmission method for convenient touch operation and transmitting data among at least two electronic devices as shown in FIG. 1 to FIG. 4 are needed.

### BRIEF SUMMARY OF THE INVENTION

The present invention provides a touch electronic device and a touch link method.

In an embodiment, the touch electronic device includes a touch panel and a touch connection module. The touch connection module includes a sensing module and a connection module. The sensing module is utilized to detect a physical adjacency between the touch electronic device and a plurality of first touch electronic devices. The connection module is utilized to develop a touch link between the touch electronic device and the plurality of first touch electronic devices through the touch panel when the sensing module detects the physical adjacency.

In another embodiment, the present invention provides a touch link method applied for a touch electronic device. The touch link method includes detecting a physical adjacency between the touch electronic device and a plurality of first touch electronic devices through a sensing module of the touch electronic device; and developing a touch link between the touch electronic device and the plurality of first touch electronic devices through a touch panel of the touch electronic device when the sensing module detects the physical adjacency.

The touch electronic device and the touch link method of the preset invention could be utilized to easily develop the touch link among at least two electronic devices for data transmission.

### BRIEF DESCRIPTION OF THE DRAWINGS

The present invention can be more fully understood by reading the subsequent detailed description and examples with references made to the accompanying drawings, wherein:

FIG. 1 is a schematic diagram of the touch connection between a first touch panel device and a second touch panel device in accordance with the prior art;

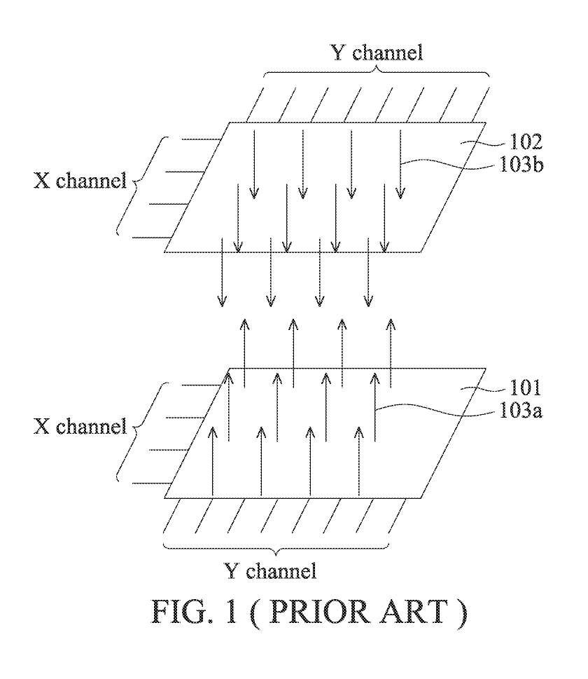

FIG. 2 is a logic chart for achieving the touch connection system between the first touch panel device and the second touch panel device in accordance with the prior art;

FIG. 3 is a schematic diagram illustrating the transmission and reception of the signal by the electrodes of the touch panel with the prior art;

FIG. 4 is a flow chart of the touch connection method in accordance with the prior art;

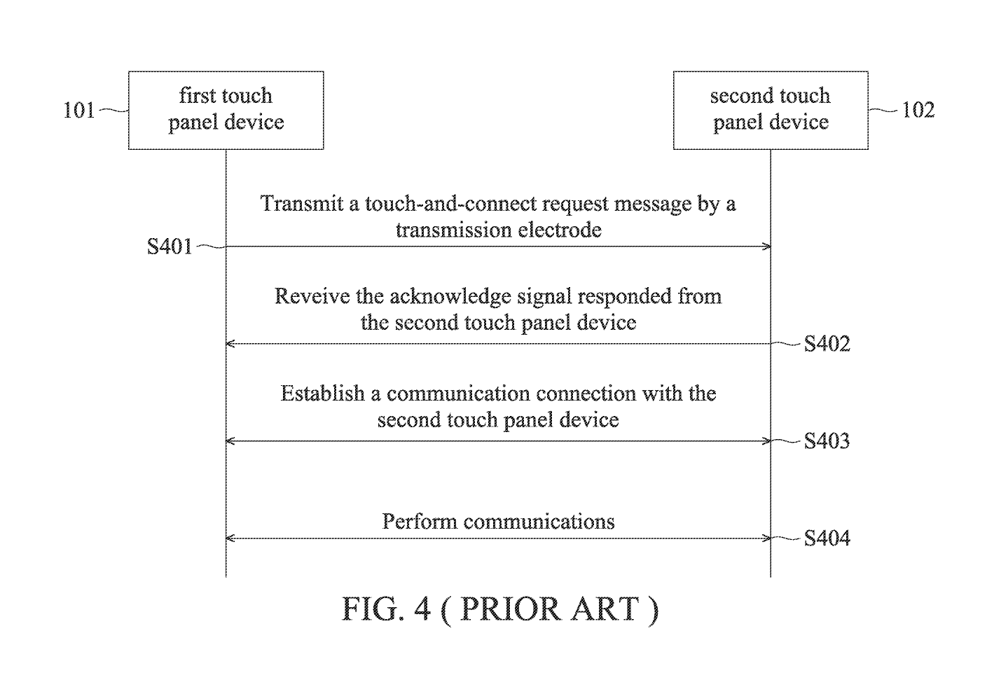

FIG. 5 is a schematic diagram illustrating a touch electronic device in accordance with the present invention;

FIG. 6A is a schematic diagram illustrating the touch connection among a plurality of touch electronic devices in accordance with the present invention;

FIG. 6B is another schematic diagram illustrating the touch connection among a plurality of touch electronic devices in accordance with the present invention;

FIG. 6C is another schematic diagram illustrating the touch connection among a plurality of touch electronic devices in accordance with the present invention;

FIG. 7A is a schematic diagram illustrating the touch link method in accordance with an embodiment of the present invention;

FIG. 7B is another schematic diagram illustrating the touch link method in accordance with an embodiment of the present invention;

FIGS. 8A and 8B are another schematic diagram illustrating the touch link method in accordance with an embodiment of the present invention;

FIGS. 9A and 9B are another schematic diagram illustrating the touch link method in accordance with an embodiment of the present invention;

FIG. 10 is another schematic diagram illustrating the touch link method in accordance with an embodiment of the present invention.

### DETAILED DESCRIPTION OF THE INVENTION

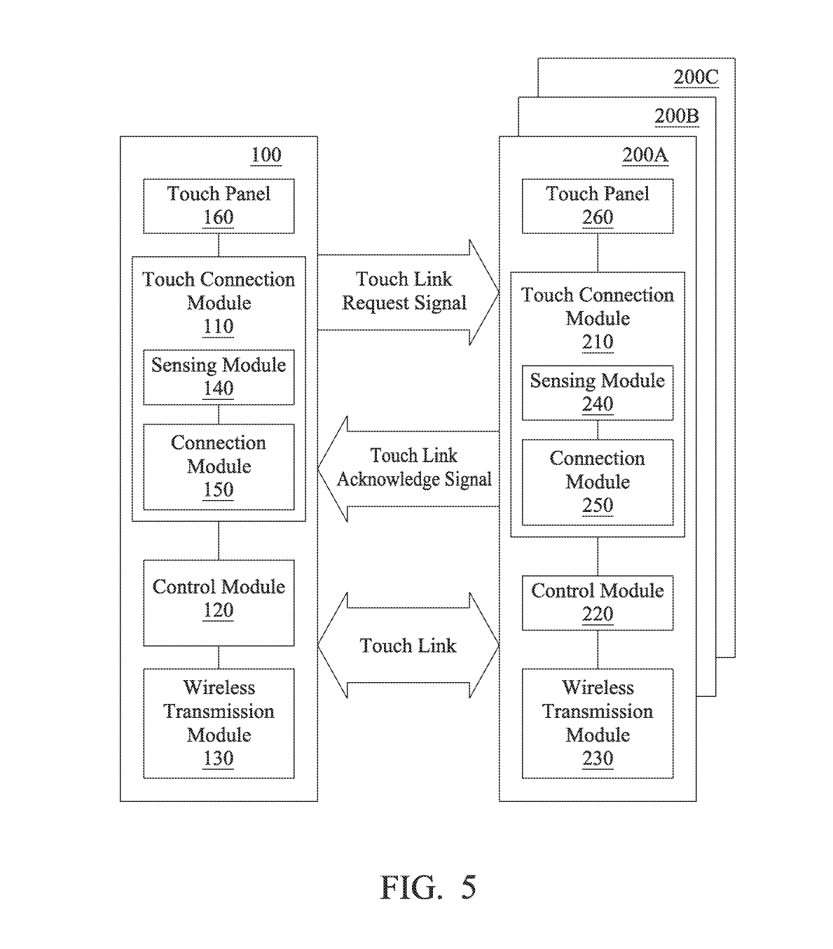

Certain terms and figures are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, the present invention is illustrated by the following embodiments and the FIG. 5 to FIG. 10. However, the devices, components, methods and steps in the following descriptions are used to explain the present invention, and are not used to limit it.

The following descriptions are the best embodiments to implement the present invention, which are utilized to illustrate the inventive principles of the present invention rather than limit them. It could be understood that the embodiments of the present invention could be implemented by software, hardware, components or their combinations.

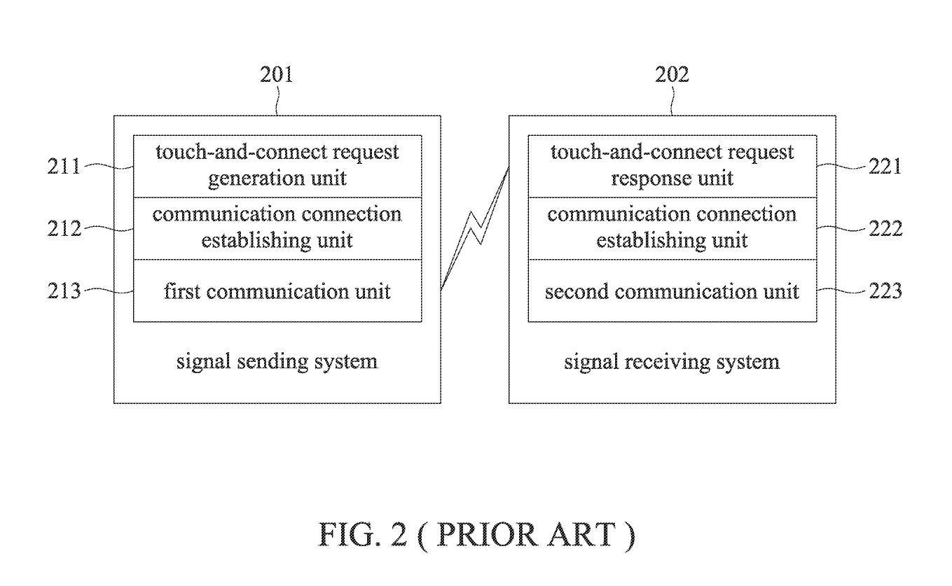

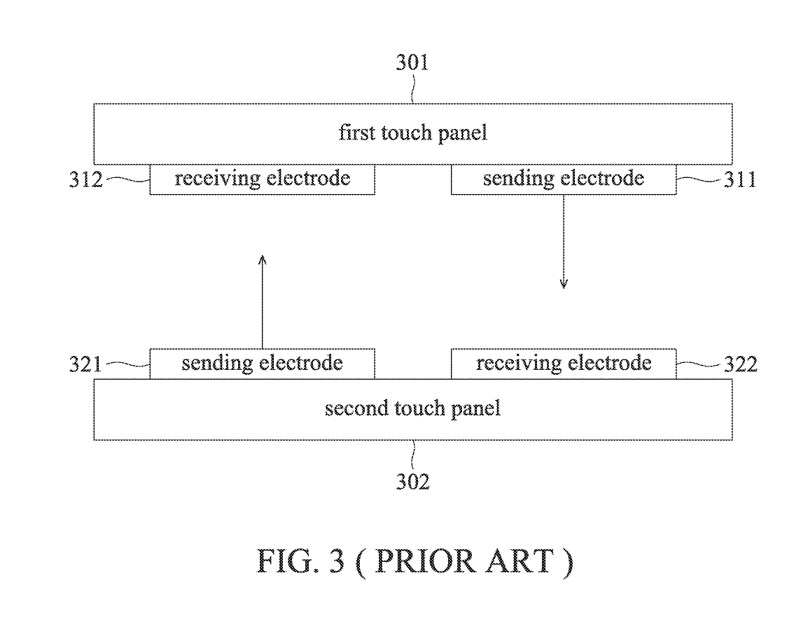

FIG. 5 is a schematic diagram illustrating a touch electronic device in accordance with the present invention. As shown in FIG. 5, the touch electronic device 100 includes a touch connection module 110, a control module 120, a wireless transmission module 130 and a touch panel 160. The touch electronic devices 200A, 200B and 200C include touch connection modules 210, control modules 220, wireless transmission modules 230 and touch panels 260. For example, the touch electronic devices 100, 200A, 200B and/or 200C could be mobile electronic devices such as cell phones, tablet computers, laptop computers, gaming apparatuses, e-books or PDAs, or could be electronic devices such as desktop computers, servers, ticket booths, digital picture frame selling terminals or digital maps, or could be any electronic devices equipped with touch connection modules (such as touch IC). The control modules 120 and 220 could be digital signal processors (DSP), microcontrollers (MCU), central-processing units (CPU) or a plurality of parallel processors relating the parallel processing environment to implement the operating system (OS) and applications of the electronic devices. In one embodiment, the touch connection module 110 includes a sensing module 140 and a connection module 150. Similarly, the touch connection module 210 includes a sensing module 240 and a connection module 250. The sensing module 140 and the sensing module 240 have the same structures and functions. The connection module 150 and the connection module 250 have the same structures and functions. Each touch electronic device 100, 200A, 200B and/or 200C detects the physical adjacency (such as being close or touching) with a device by the sensing module 140 and/or 240. Once the physical adjacency is detected, the first communication channel is developed through the connection modules 150 and 250. For example, the sensing module 140 senses the interacting electromagnetic field (such as the method illustrated in FIG. 3, the interacting electromagnetic field is determined by the sending electrode and the receiving electrode of the touch panel) between the touch electronic device 100 and the touch electronic device 200A. Whether the touch electronic device 200A is physically adjacent to the touch electronic device 100 or not is determined by changes in the electromagnetic field. When the physical adjacency is detected, the connection module 150 develops the first communication channel with the connection module 250. In one embodiment, the connection module 150 could be the message transmission system as shown in FIG. 2, the connection module 250 could be the signal receiving system as shown in FIG. 2. The first communication unit 213 as shown in FIG. 2 develops the first communication channel with the second communication unit 223 through the touch panel 160 of the touch electronic device 100 and the touch panel 260 of the touch electronic device 200A. As shown in FIG. 5, in the touch electronic device 100, the wireless transmission module 130 is also coupled to the control module 120. The wireless transmission module 130 develops the second communication channel with the touch electronic device 200A. The second communication channel executes wireless communication on the basis of a wireless communication protocol. The protocol of wireless communication could include GSM, GPRS, EDGE, UMTS, W-CDMA, CDMA2000, TD-CDMA, Bluetooth, NFC, WiFi, WiMAX, LTE, LTE-A or TD-LTE.

The wireless transmission module 130 can transmit data at a level speed of thousands of symbols per second. Each symbol could correspond to any suitable amount of data bits (for example, 0.5 bit/symbol, 1 bit/symbol and so on). The wireless transmission module 130 can implement many other data speeds which could be greater than or less than thousands of symbols per second in various kinds of embodiments. It should be noted that the implementations of the sensing module 240, the connection module 250, the control module 220 and the wireless transmission module 230 of the touch electronic device 200A are similar to the implementations of the sensing module 140, the connection module 150, the control module 120 and the wireless transmission module 130 of the touch electronic device 100, and are not repeated herein. The above embodiment describes the data transmission between the touch electronic device 100 and another touch electronic device 200A. However, the present invention is not limited thereto. Based on the same principle and steps, the touch electronic device 100 can develop communication and transmit data with several touch electronic devices (such as touch electronic devices 200A, 200B and 200C), and are not repeated herein.

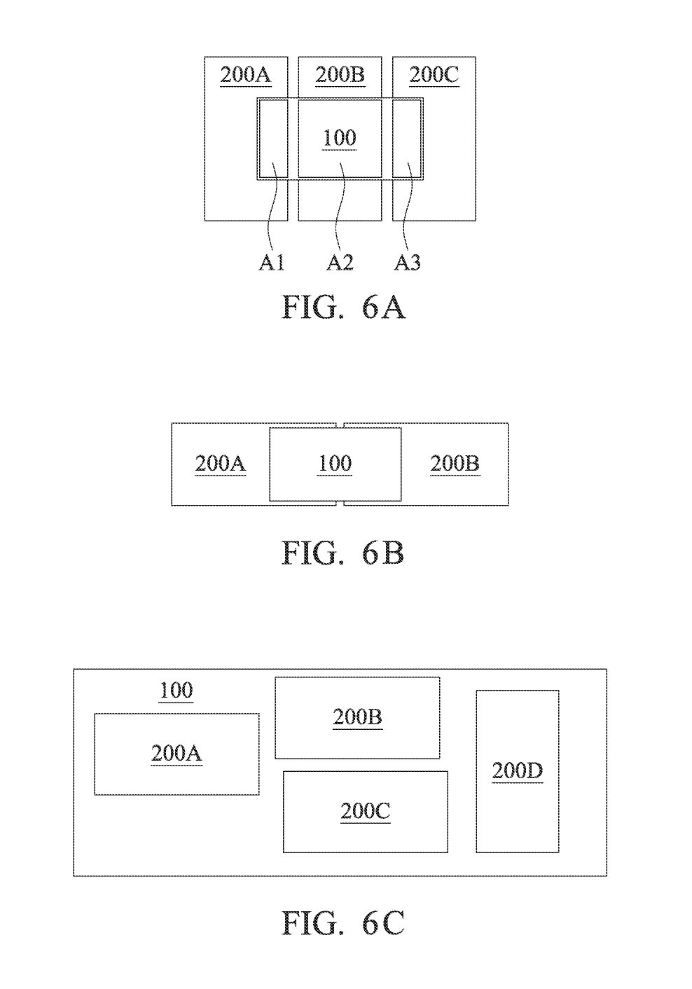

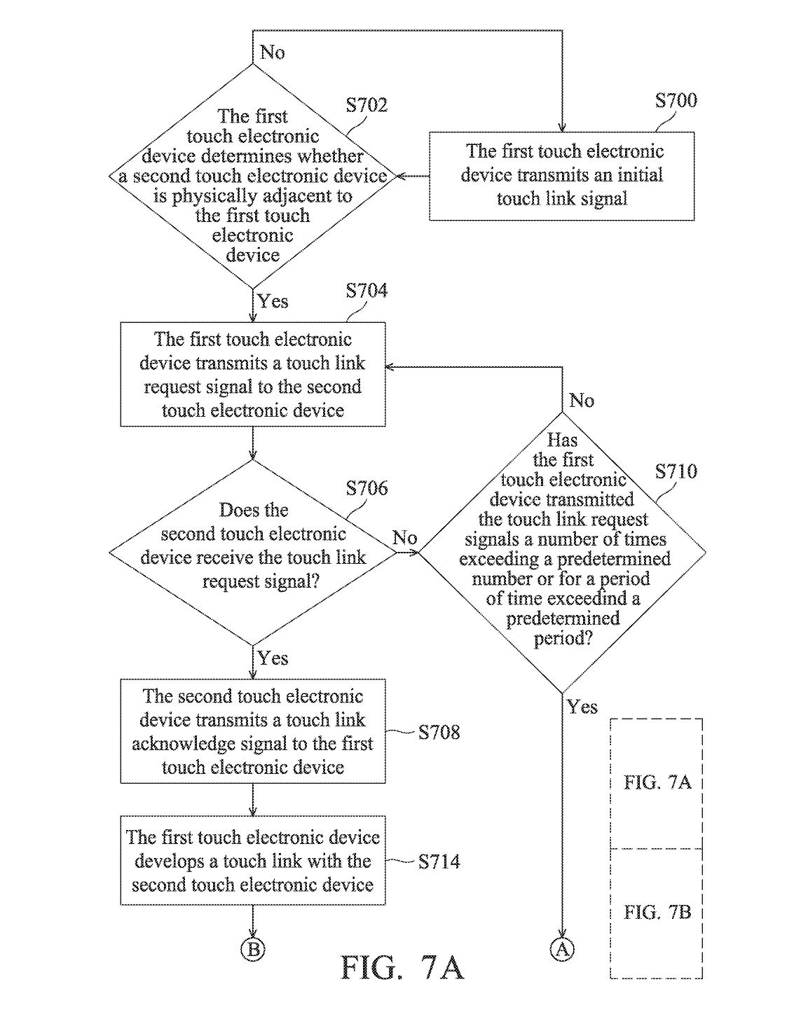

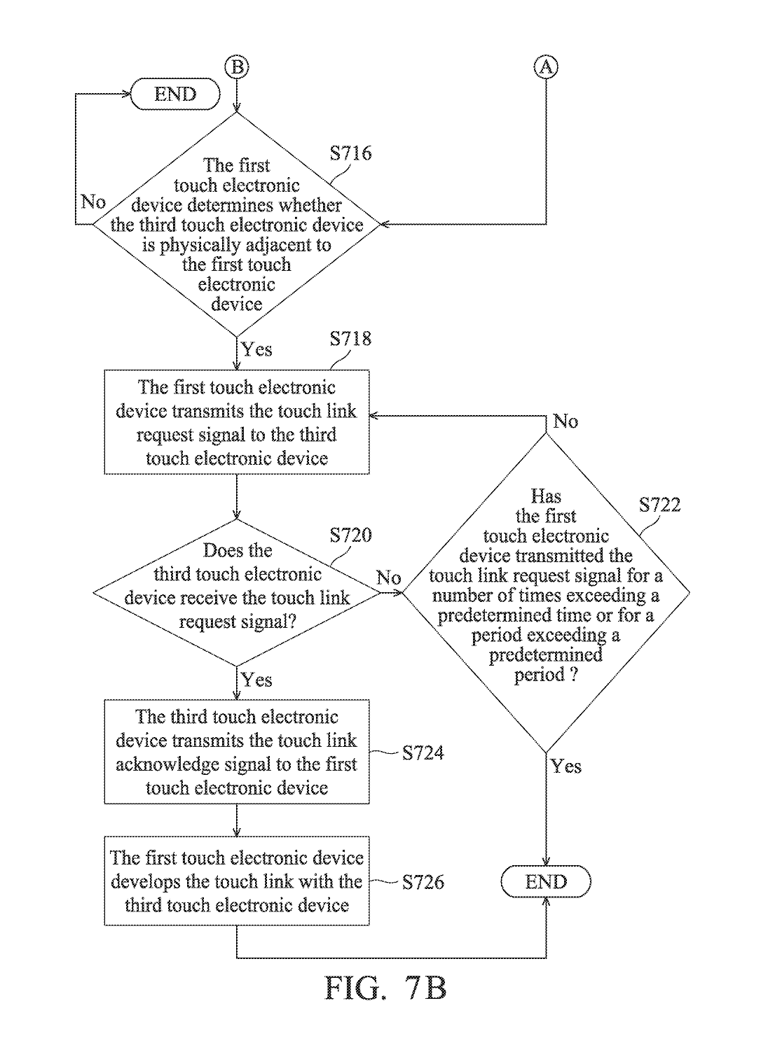

FIG. 6A is a schematic diagram illustrating the touch connection among a plurality of touch electronic devices in accordance with the present invention. As shown in FIG. 6A, the touch electronic device 100 is physically adjacent to the touch electronic devices 200A, 200B and 200C. The adjacent areas of the touch electronic device 100 with the touch electronic devices 200A, 200B and 200C are A1, A2 and A3 respectively. When the touch electronic device 100 and the touch electronic device 200A are close to each other for developing communications, the electromagnetic field which is originally related to the touch electronic device 100 could affect the sensing module 240 of the touch electronic device 200A. Similarly, another electromagnetic field which is originally related to the touch electronic device 200A could affect the sensing module 140 of the touch electronic device 100. When the distance of the touch electronic device 100 and the touch electronic device 200A is in the scale of millimeters (mm), for example, 5 mm, they can be considered to be adjacent. The distance is determined by the features of the related touch electronic device and its sensing module. For example, the distance of 0.3 mm to 0.8 mm could be considered physically adjacent. In other words, when the distance between the touch electronic device 100 and the touch electronic device 200A is smaller than or equal to a predetermined maximum distance (such as 5 mm), the touch electronic device 100 determines that it is physically adjacent to the touch electronic device 200A.

In one embodiment, if the contact area A1 of the touch electronic devices 100 and 200A is larger than the predetermined area value, the touch electronic device 100 determines that it is adjacent to or in contact with the touch electronic device 200A. In one embodiment, the predetermined area value is one-fourth to one-third of the touch screen of the touch electronic device 100. In another embodiment, the predetermined area value is about 20% to 40% of the touch screen of the touch electronic device 100. For example, the predetermined area value is 35% of the touch screen of the touch electronic device 100. Since the contact area A2 is larger than the predetermined area value, the touch electronic device 100 determines it is adjacent to or contacts the touch electronic device 200B. Since the contact area A1 or A3 is not larger than the predetermined area value, the touch electronic device 100 determines that it is not adjacent to or contacts the touch electronic device 200A or 200C.

FIG. 6B is another schematic diagram illustrating the touch connection among a plurality of touch electronic devices in accordance with the present invention. The touch electronic device 100 covers the touch screens of the touch electronic devices 200A and 200B. FIG. 6C is another schematic diagram illustrating the touch connection among a plurality of touch electronic devices in accordance with the present invention. As shown in FIG. 6C, the touch screen of the touch electronic device 100 is covered by the touch electronic devices 200A, 200B, 200C and 200D. Accordingly, the adjacency, contact or covering among several touch electronic devices could be considered a manner of touch link. Whether the touch link is effective or not and whether the touch link is completed or not could be determined by the distance and/or the contact area between the touch electronic devices.

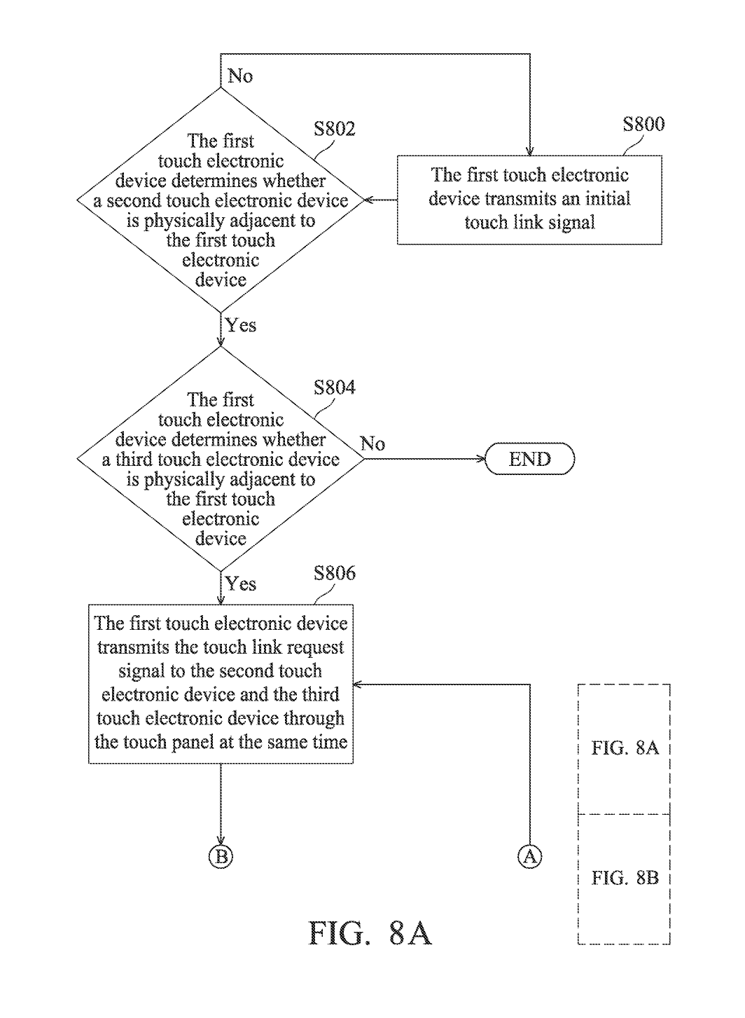

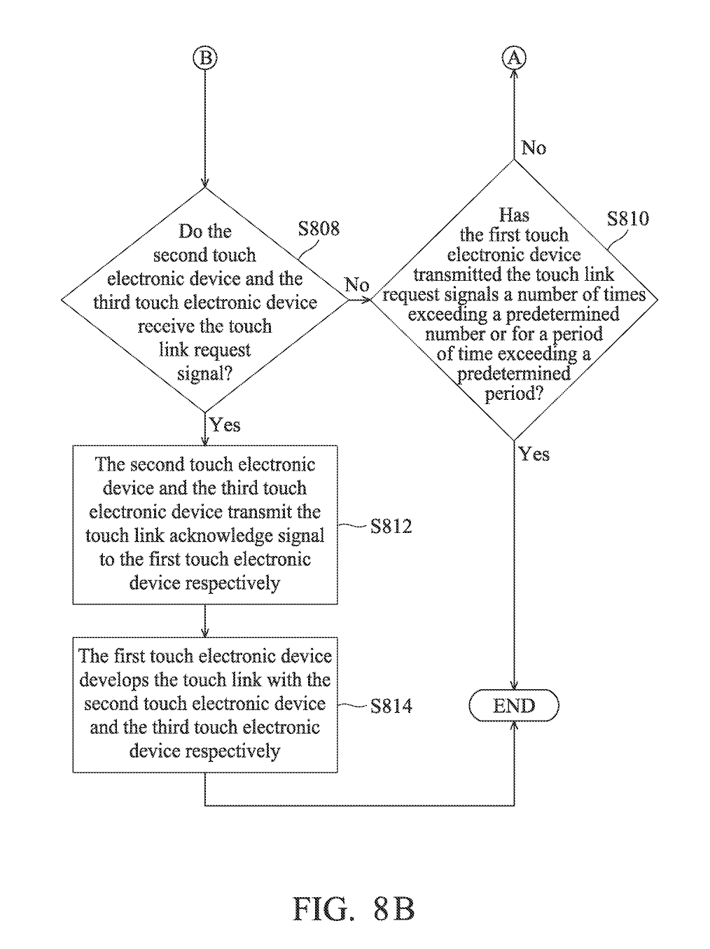

FIG. 7A and FIG. 7B are schematic diagrams illustrating the touch link method in accordance with an embodiment of the present invention, which are illustrated by the physical adjacency between two touch electronic devices and a main touch electronic device. However, the present invention is not limited to it. First, in step S700, the first touch electronic device (such as the touch electronic device 100) transmits an initial touch link signal. Afterwards, in step S702, the first touch electronic device determines whether a second touch electronic device (such as the touch electronic device 200A) is physically adjacent to the first touch electronic device. In other words, the physical adjacency is detected by the sensing module of the first touch electronic device. When the above second touch electronic device exists, step S704 is executed. When the above second touch electronic device does not exist, step S700 is executed. In step S704, the first touch electronic device transmits a touch link request signal to the second touch electronic device. In other words, the first touch electronic device transmits a touch link request signal to the second touch electronic device thorough the connection module. Afterwards, in step S706, whether the second touch electronic device receives the touch link request signal from the first touch electronic device or not is determined. When the result is “YES”, step S708 is executed and the second touch electronic device transmits a touch link acknowledge signal to the first touch electronic device, and the first touch electronic device receives the above touch link acknowledge signal through the touch panel. When the result is “NO”, step S710 is executed and the control module of the first touch electronic device determines whether the first touch electronic device has transmitted the touch link request signals for a number of times exceeding a predetermined number or for a period of time exceeding a predetermined period. When the result is “NO”, step S704 is executed that the first touch electronic device keeps transmitting a touch link request signal to the second touch electronic device. Otherwise, step S716 is executed. After step S708, the first touch electronic device develops a touch link with the second touch electronic device (i.e. developing the first communication channel) as shown in step S714. Afterwards, as shown in FIG. 7B, step S716 is executed that the first touch electronic device determines whether the third touch electronic device (such as the touch electronic device 200B) is physically adjacent to the first touch electronic device. When it is physically adjacent to the first touch electronic device, step S718 is executed. Otherwise, the procedure ends. In step S718, the first touch electronic device transmits the touch link request signal to the third touch electronic device. Afterwards, in step S720, whether the third touch electronic device receives the touch link request signal or not is determined. When it is not received, step S722 is executed. Otherwise, step S724 is executed that the third touch electronic device transmits the touch link acknowledge signal to the first touch electronic device. As shown in step S722, The control module of the first touch electronic device determines whether the first touch electronic device has transmitted the touch link request signal for a number of times exceeding a predetermined time (for example, 10 times) or whether the first touch electronic device has transmitted the touch link request signal for a period exceeding a predetermined period (for example, 15 seconds). When the result is “NO”, step S718 is executed that the first touch electronic device keeps transmitting the touch link request signal to the third touch electronic device. When the result is “YES”, the procedure ends. After step S724, step S726 is executed that the first touch electronic device develops the touch link (i.e. the first communication channel) with the third touch electronic device, and the procedure ends. The above touch link method is illustrated with three touch electronic devices. In another embodiment, the above touch link method could be applied to more touch electronic devices, such as the touch electronic devices 100, 200A, 200B and 200C as shown in FIG. 6A. According to the above touch link method, it will be understand by a person skilled in the art that after step S726, whether a fourth touch electronic device (such as the touch electronic device 200C) is physically adjacent to the first touch electronic device or not could be determined. The detailed illustration could be easily inferred and would not be repeated.

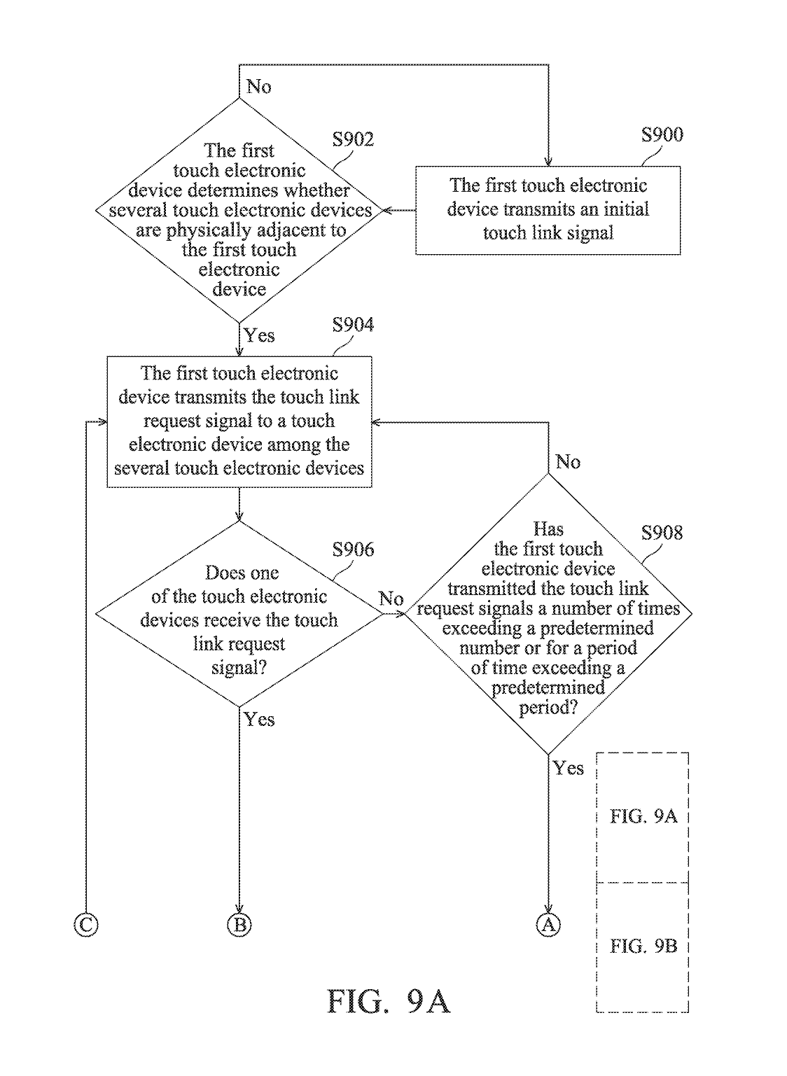

FIGS. 8A and 8B are another schematic diagram illustrating the touch link method in accordance with an embodiment of the present invention. For simplicity, it is illustrated by the physical adjacency with two touch electronic devices and the main touch electronic device, but the present invention is not limited to it. At first, in step S800, the first touch electronic device (such as the touch electronic device 100) transmits the initial touch link signal. Afterwards, step S802 is executed that the first touch electronic device determines whether a second touch electronic device (such as the touch electronic device 200A) is physically adjacent to the first touch electronic device. In other words, the sensing module of the first touch electronic device is utilized to detect whether the physical adjacency exists or not. When the above second touch electronic device exists, step S804 is executed. Otherwise, step S800 is executed. In step S804, the first touch electronic device determines whether a third touch electronic device (such as the touch electronic device 200B) is physically adjacent to the first touch electronic device. When the above third touch electronic device exists, step S806 is executed. Otherwise, the procedure ends. In step S806, the connection module of the first touch electronic device transmits the touch link request signal to the second touch electronic device and the third touch electronic device through the touch panel at the same time. Afterwards, in step S808, whether the second touch electronic device and the third touch electronic device receive the touch link request signal from the first touch electronic device or not is determined. When the result is “YES”, as shown in step S812, the second touch electronic device and the third touch electronic device transmit the touch link acknowledge signal to the first touch electronic device respectively. When the result is “NO”, step S810 is executed that the control module of the first touch electronic device determines whether the first touch electronic device has transmitted the touch link request signal more than a predetermined number of times (for example, 10 times) or whether the first touch electronic device has transmitted the touch link request signal for a period exceeding a predetermined period (for example, 15 seconds). When the result is “NO”, step S806 is executed that the first touch electronic device keeps transmitting the touch link request signal to the second touch electronic device and the third touch electronic device respectively. Otherwise, the procedure ends. As shown in step S814, the first touch electronic device develops the touch link (i.e. the first communication channel) with the second touch electronic device and the third touch electronic device respectively, and the procedure ends. The above touch link method is illustrated with three touch electronic devices. In another embodiment, the above touch link method could be applied to more touch electronic devices, such as the touch electronic devices 100, 200A, 200B and 200C as shown in FIG. 6A. According to the above touch link method, it could be known by the people skilled in the art that in steps S802 and S804, whether a fourth touch electronic device (such as the touch electronic device 200C) is physically adjacent to the first touch electronic device or not could be determined. The detailed illustration after step S804 is similar and would not be repeated.

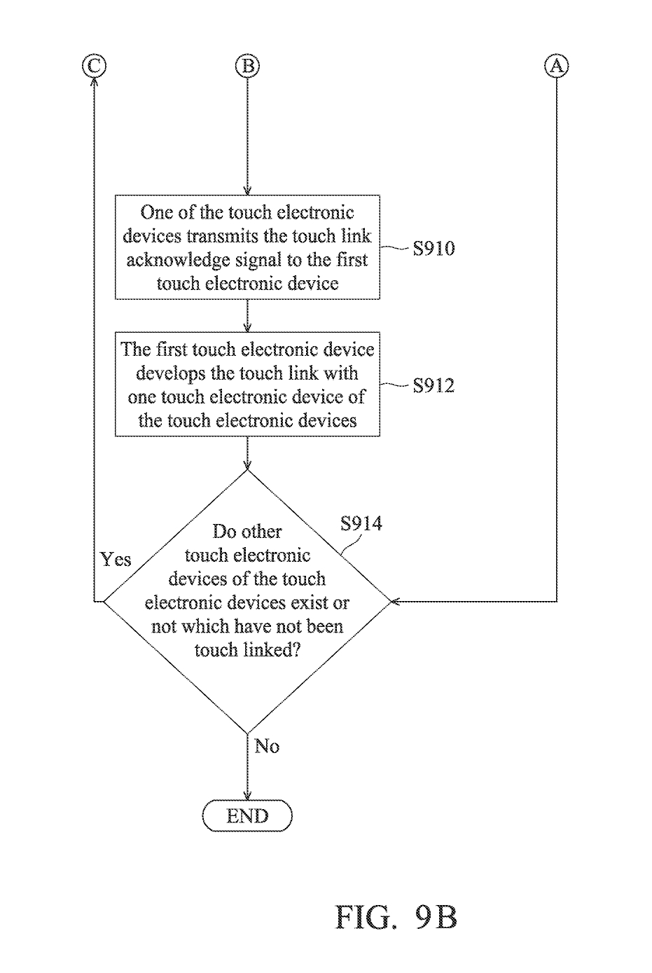

FIGS. 9A and 9B are another schematic diagram illustrating the touch link method in accordance with an embodiment of the present invention. At first, in step S900, the first touch electronic device (such as the touch electronic device 100) transmits the initial touch link signal. Afterwards, step S902 is executed that the first touch electronic device determines whether several touch electronic devices are physically adjacent to the first touch electronic device. In other words, the sensing module of the first touch electronic device is utilized to detect whether the physical adjacency exists or not. When the above touch electronic devices exist, step S904 is executed. Otherwise, step S900 is executed. In step S904, the connection module of the first touch electronic device transmits the touch link request signal to a touch electronic device among the several touch electronic devices. Afterwards, in step S906, whether the above one of the touch electronic devices receives the touch link request signal from the first touch electronic device or not is determined. When the result is “YES”, as shown in step S910, the above one of the touch electronic devices transmits the touch link acknowledge signal to the first touch electronic device. When the result is “NO”, step S908 is executed that the control module of the first touch electronic device determines whether the first touch electronic device has transmitted the touch link request signal more than a predetermined number of times (for example, 10 times) or whether the first touch electronic device has transmitted the touch link request signal for a period exceeding a predetermined period (for example, 15 seconds). When the result is “NO”, step S904 is executed that the first touch electronic device keeps transmitting the touch link request signal to one of the above touch electronic devices. Otherwise, step S914 is executed. After step S910, as shown in step S912, the first touch electronic device develops the touch link (i.e. the first communication channel) with one touch electronic device of the above touch electronic devices. Afterwards, step S914 is executed that it is determined whether other touch electronic devices of the touch electronic devices exist or not which have not been touch-linked with the first touch electronic device. When the result is “YES”, step S904 is executed that the first touch electronic device transmits the touch link request signal to another touch electronic device among the several touch electronic devices. Otherwise, the procedure ends.

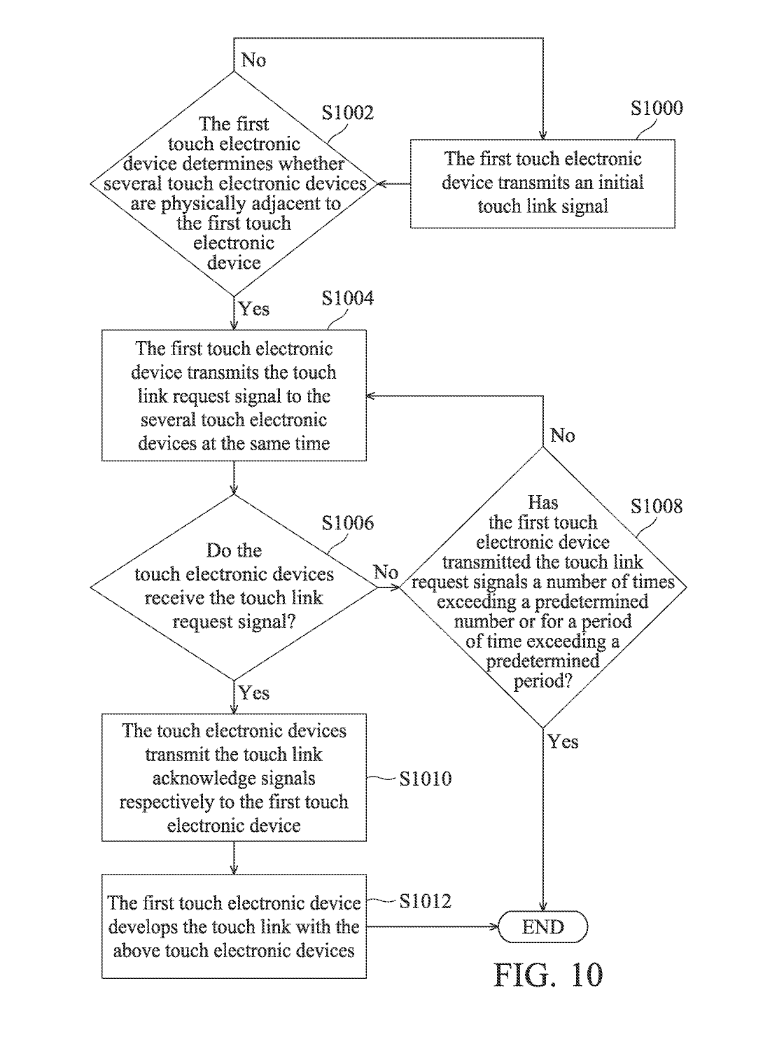

FIG. 10 is another schematic diagram illustrating the touch link method in accordance with an embodiment of the present invention. At first, in step S1000, the first touch electronic device (such as the touch electronic device 100) transmits the initial touch link signal. Afterwards, step S1002 is executed that the first touch electronic device determines whether several touch electronic devices are physically adjacent to the first touch electronic device. In other words, the sensing module of the first touch electronic device is utilized to detect whether the physical adjacency exists or not. When the above touch electronic devices exist, step S1004 is executed. Otherwise, step S1000 is executed. In step S1004, the connection module of the first touch electronic device transmit the touch link request signal to the several touch electronic devices at the same time. Afterwards, step S1006 is executed that whether the above touch electronic devices receive the touch link request signal from the first touch electronic device or not. When the result is “YES”, as shown in step S1010, the above touch electronic devices transmit the touch link acknowledge signals respectively to the first touch electronic device. When the result is “NO”, step S1008 is executed that the control module of the first touch electronic device determines whether the first touch electronic device has transmitted the touch link request signal more than a predetermined number of times (for example, 10 times) or whether the first touch electronic device has transmitted the touch link request signal for a period exceeding a predetermined period (for example, 15 seconds). When the result is “NO”, step S1004 is executed that the first touch electronic device keeps transmitting the touch link request signal to one of the above touch electronic devices. Otherwise, the procedure ends. After step S1010, as shown in step S1012, the first touch electronic device develops the touch link (i.e. the first communication channel) with the above touch electronic devices. Afterwards, the procedure ends.

Regarding the schematic diagrams illustrating the touch link methods as shown in FIG. 7 to FIG. 10, people skilled in the art will understand that the connection module of the first touch electronic device could be utilized to record the touch link status with other touch electronic devices. As shown in FIG. 9, in step S914, when the touch link is determined to be developed between one of the touch electronic devices (such as the touch electronic device 200A) and the first touch electronic device, it would be informed by the feedback signal that the touch link has been developed between the first touch electronic device and the touch electronic device 200A. Therefore, in the following step S904, the first touch electronic device will transmit the touch link request signal to the touch electronic devices other than the touch electronic device 200A. In the same way, people in the art could understand that as shown in FIG. 7 and FIG. 8, when determining whether there is physical adjacency between the first touch electronic device and other touch electronic devices or not, a step could be added that the first touch electronic device determines whether the touch link has been developed with other touch electronic devices or not. When the touch link has been developed with other touch electronic devices (such as the touch electronic device 200B), the first touch electronic device keeps checking to determine the physical adjacency with other touch electronic devices rather than with the touch electronic device 200B.

In addition, other touch electronic devices for connection (such as the touch electronic device 200C) could be utilized to record their touch link status with the first touch electronic device respectively. When the first touch electronic device determines whether it is physically adjacent to the above other touch electronic devices, the above other touch electronic devices could be utilized to respectively inform the first touch electronic device by a signal about their touch link status with the first touch electronic device. When the above touch link status indicates that the touch link has been developed, the touch link process with the touch electronic device 200C would be skipped.

The schematic diagrams of the touch link methods as shown in FIG. 7 to FIG. 10 respectively disclose the embodiments that the first touch electronic device determines its physical adjacency between several touch electronic devices simultaneously or sequentially, and the first touch electronic device transmits touch link request signals to the touch electronic devices simultaneously or sequentially. Through the above methods, the first touch electronic device could develop touch links with several touch electronic devices simultaneously or sequentially.

As illustrated above, the present invention provides a touch electronic device and a touch link method for developing touch link easily among at least two electronic devices and providing the convenience of touch operation. By utilizing the touch electronic device and data transmission method of the present invention, the users do not need to set up the network and connection for each electronic device to easily develop the above touch link.

The embodiments of the above touch link methods according to the present invention could be implemented by various kinds of hardware, software codes or the combination of them. For example, the embodiments of the present invention could be circuits of the integrated video compression chip or the integrated video compression software to execute the program code of the above process. The embodiments of the present invention could be the program codes executed by the digital signal processor (DSP). The present invention could also relate to several functions executed by the computer processor, the DSP, the microcontroller or the field programmable gate array (FPGA). The above processors could be arranged according to the present invention to execute certain functions which could be performed by the fixed code or the machine-readable software code of the specific methods disclosed by the present invention. The software code or fixed code could be developed as different programs or different formats, or could be compiled for different object platform. However, the different code, type or language of the software code and other types of allocation code according to the present invention is not away from the scope or range of the present invention.

The terms such as “first”, “second”, “third” for describing the components in the specifications or claims do not indicate any priority right, priority sequence, or a timing sequence that a level of a component is higher than the level of another component or execution method. They are only labels to distinguish a component with specific name and another component with the same name (except the describing term).

While the invention has been described by way of example and in terms of the preferred embodiments, it is to be understood that the invention is not limited to the disclosed embodiments. On the contrary, it is intended to cover various modifications and similar arrangements as would be apparent to those skilled in the art. In addition, those skilled in the art should appreciate that they can readily use the disclosed conception and specific embodiments as a basis for designing or modifying other structures for carrying out the same purposes of the present invention without departing from the scope of the invention as defined by the appended claims.

What is claimed is:

1. A touch electronic device, comprising:
a touch panel; and
a touch connection module, wherein the touch connection module comprises a sensing module and a connection module, the sensing module is utilized to detect a physical adjacency between the touch electronic device and a plurality of first touch electronic devices, and the connection module is utilized to develop a touch link between the touch electronic device and the plurality of first touch electronic devices through the touch panel when the sensing module detects the physical adjacency.

2. The touch electronic device as claimed in claim 1, wherein when a distance between the touch electronic device and the plurality of first touch electronic devices is smaller than or equal to 5 mm, the sensing module of the touch electronic device determines that the touch electronic device is physically adjacent to the plurality of first touch electronic devices.

3. The touch electronic device as claimed in claim 2, wherein the sensing module of the touch electronic device determines the physical adjacency between the touch electronic device and the plurality of first touch electronic devices simultaneously or sequentially.

4. The touch electronic device as claimed in claim 2, wherein after the sensing module of the touch electronic device detects the physical adjacency between the touch electronic device and the plurality of first touch electronic devices, the connection module of the touch electronic device transmits a touch link request signal to the plurality of first touch electronic devices through the touch panel.

5. The touch electronic device as claimed in claim 4, wherein the connection module of the touch electronic device transmits the touch link request signal to the plurality of first touch electronic devices simultaneously or sequentially to develop the touch link between the touch electronic device and the plurality of first touch electronic devices simultaneously or sequentially.

6. The touch electronic device as claimed in claim 4, wherein after the connection module of the touch electronic device transmits the touch link request signal to the plurality of first touch electronic devices, the connection module of the touch electronic device determines whether a plurality of touch link acknowledge signals are received respectively from the plurality of first touch electronic devices through the touch panel or not.

7. The touch electronic device as claimed in claim 6, wherein when the plurality of touch link acknowledge signals are received respectively from the plurality of first touch electronic devices, the touch electronic device develops the touch link with the plurality of first touch electronic devices.

8. The touch electronic device as claimed in claim 6, wherein the touch electronic device further comprises a control module, when the plurality of touch link acknowledge signals are not received respectively from the plurality of first touch electronic devices, the control module of the touch electronic device determines whether the touch electronic device has transmitted the touch link request signals a number of times exceeding a predetermined number or for a period of time exceeding a predetermined period or not.

9. The touch electronic device as claimed in claim 1, wherein after the touch link has been developed, the connection module of the touch electronic device records a touch link status.

10. The touch electronic device as claimed in claim 1, wherein after the touch link has been developed, the plurality of first touch electronic devices record their touch link statuses with the touch electronic device respectively, and when the touch electronic device determines whether it is physically adjacent to the plurality of first touch electronic devices or not, the touch electronic device receives the touch link statuses through the touch panel.

11. A touch link method applied for a touch electronic device, comprising:
detecting a physical adjacency between the touch electronic device and a plurality of first touch electronic devices through a sensing module of the touch electronic device; and
developing a touch link between the touch electronic device and the plurality of first touch electronic devices through a touch panel of the touch electronic device when the sensing module detects the physical adjacency.

12. The touch link method as claimed in claim 11, wherein when a distance between the touch electronic device and the plurality of first touch electronic devices is smaller than or equal to 5 mm, the touch electronic device is physically adjacent to the plurality of first touch electronic devices is determined through the sensing module.

13. The touch link method as claimed in claim 12, wherein the physical adjacency between the touch electronic device and the plurality of first touch electronic devices is determined simultaneously or sequentially through the sensing module of the touch electronic device.

14. The touch link method as claimed in claim 12, wherein the touch link method further comprises, after the sensing module of the touch electronic device detects the physical adjacency between the touch electronic device and the plurality of first touch electronic devices, transmitting a touch link request signal to the plurality of first touch electronic devices through the touch panel by the connection module of the touch electronic device.

15. The touch link method as claimed in claim 14, wherein the touch link method further comprises transmitting the touch link request signal to the plurality of first touch electronic devices simultaneously or sequentially to develop the touch link between the touch electronic device and the plurality of first touch electronic devices simultaneously or sequentially.

16. The touch link method as claimed in claim 14, wherein the touch link method further comprises, after the connection module of the touch electronic device transmits the touch link request signal to the plurality of first touch electronic devices, determining whether a plurality of touch link acknowledge signals are received respectively from the plurality of first touch electronic devices through the touch panel or not.

17. The touch link method as claimed in claim 16, wherein the touch link method further comprises when the plurality of touch link acknowledge signals are received respectively from the plurality of first touch electronic devices, the touch electronic device develops the touch link with the plurality of first touch electronic devices.

18. The touch link method as claimed in claim 16, wherein the touch link method further comprises when the plurality of touch link acknowledge signals are not received respectively from the plurality of first touch electronic devices, determining whether the touch electronic device has transmitted the touch link request signals a number of times exceeding a predetermined number or for a period of time exceeding a predetermined period or not by a control module of the touch electronic device.

19. The touch link method as claimed in claim 11, wherein the touch link method further comprises after the touch link has been developed, recording a touch link status.

20. The touch link method as claimed in claim 11, wherein the touch link method further comprises, after the touch link has been developed, recording touch link statuses between the plurality of first touch electronic devices and the touch electronic device respectively by the plurality of first touch electronic devices, and when the touch electronic device determines whether it is physically adjacent to the plurality of first touch electronic devices or not, receiving the touch link statuses through the touch panel of the touch electronic device.
